(19) United States
(12) Patent Application Publication
(10) Pub. No.: US 2004/0157691 A1
(43) Pub. Date: Aug. 12, 2004

(54) Zipper chain drive assembly

(75) Inventor: Robert Olmsted, Wood Dale, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/365,228

(22) Filed: Feb. 12, 2003

(51) Int. Cl. F16H 55/30; F16G 13/02

(52) U.S. Cl. 474/152; 474/206

(57) ABSTRACT

A multi-strand chain forms a chain drive including at least two chains so that the chain drive may communicate a force when the chain is pushed or pulled. The chains may be separated or disengage so as to be stored compactly. The chains may be engaged to form the chain drive so that the chain drive is substantially rigid and in a linear orientation, and pivotally connected chain links may not substantially rotate relative to each other and may not be deflected substantially from the linear orientation. The chains may be engaged and disengaged by rotating around sprockets which deliver the force to the chain drive. The chain drive may be utilized as a garage door system for raising or moving laterally a garage door or movable barrier with the chain drive in compression.

### FIELD OF THE INVENTION

The present invention relates to a chain drive assembly, and, more specifically, to a chain drive assembly for directing a force both in a pull direction and push direction such as for moving a garage door or movable barrier.

### BACKGROUND OF THE INVENTION

Typically, a chain is operable in only a pull direction. A chain, by definition, is a series of interlinked sections, or links, which are free to move relative to each other, at least to some degree. Accordingly, when one end of a chain is pulled in a direction, the links aligned in a linear path and provide a tension force on that which an second end of the chain is attached. Chains are often desirable in many uses as a chain provides the strength, wear, and environmental properties of steel, while also being able to be stored compactly in a coil, for example.

Because of the links being movable relative to each other, the links are unable to provide a force in compression. That is, when a force is applied towards the chain, the links tend to deviate from their alignment and, as such, are unable to provide a force in a push direction. In addition, the links of a chain may be deflected in a direction lateral to their alignment. A transverse force applied to the chain will cause the links to deviate from their alignment. In order to prevent the links from deviating, the chain must be located within a closely-aligned track (or transmission rail) to constrain the links, a track which results in considerable friction and may cause seizing of the chain within the track.

As an example, conventional drive systems for automatically raising and lowering movable barriers, such as a garage door or a gate, often involve relatively large and cumbersome components. Specifically, many conventional automatic garage door systems include a garage door, a head unit mounted to the garage ceiling in a position for pulling a chain attached to the center of the garage door, a motor, door rails along which the sides of a garage door are moved, and a controller located in the head unit that is operative to energize the motor to raise and lower the door. Many garage door operator systems also include a hand-held transmitter unit adapted to send signals to an antenna positioned on the head unit and a wall control connected to the head unit. Furthermore, many garage door systems include a transmission rail for the chain, or transmission means, for raising and lowering the garage door.

A number of disadvantages are present in the use of garage door systems of this type. For instance, the head unit is usually installed on the ceiling aligned with the center of the garage door, extending down from the ceiling into the interior of the garage. If a garage ceiling is particularly low, a garage door systems of this type cannot be installed because the system may create an obstruction to vehicles or other items which require clearance in the garage. In addition, if the ceiling is particularly high, a rigid support structure must be attached to the ceiling for placing the head unit in the proper alignment with the direction of the pull on the garage door. Often times, this requires a custom installation of the head unit to the support structure.

Another disadvantage is that many conventional systems include a transmission rail for supporting the chain. The transmission rail is typically made of hardened metal and is relatively lengthy, approximately eight feel long. Accordingly, the transmission rail is expensive and cumbersome to install.

Due to the components of a typical chain-type garage door system, the systems are typically difficult to remove once installed and are not easily transferable. As the height of the ceiling in which the system is installed determines the mounting of the head unit, the system is not easily removed and re-installed in a different garage. Furthermore, the door rails and transmission rail are not easily transferred to a different garage due to their length, weight, and installation into a concrete floor, into the walls surrounding the garage door, and into the ceiling.

These facts may discourage people from purchasing and installing a garage door system. The systems require expensive, heavy components, often require custom installation by a professional, and are difficult to remove and transfer. At times, these systems are simply unable to be utilized in some garages.

An alternative to a chain-type garage door system is a screw-type system. In a screw-type, all the components detailed above are required. However, instead of utilizing a chain which is operable only in a pull direction, a screw is utilized which may provide operate in a push direction, as well as a pull direction. However, the screw must extend at least a distance equal to the length of travel of the door from a closed position to an open position. This requires a screw of a length often eight feet or more made of steel with hardened threads for wear and strength. Accordingly, the screw is somewhat expensive, as well as requiring the transmission rail or other means for support.

A single chain which may be utilized in a push direction, which may be referred to as a push-pull chain, are known in the art. However, these chains must consider transverse forces that would otherwise cause a chain to deflect or deviate from a linear alignment. For example, a chain may be made such that it may deflect only in one particular direction, and the portion of the chain being utilized in a push direction may rest against a flat surface such that the direction of deflection of the chain is against the flat surface. Such a chain is disclosed for example, in U.S. Pat. No. 6,173,352 to Beausoleil.

### SUMMARY OF THE INVENTION

In accordance with the present invention, a chain drive assembly is provided which may be utilized to transmit a force in both a push and pull direction. In conjunction with a garage door system, the chain drive assembly of the present invention does not require a support rail, and does not require mounting on the ceiling of the garage. The chain drive assembly includes at least two chains (multi-chain, or multi-strand) with pivotally-connected links. The links of each strand have interfering portions such that the links of one chain cooperate with interfering portions of the links of another chain to inhibit the of the links relative to each other. The result is a rigid chain drive assembly that may be directed in both a push and pull directions, and also resists transverse forces applied to the chain. In addition, the interfering links may be easily separated so that each chain may be coiled or otherwise stored compactly.

As used in the system, the multi-strand rigid chain drive includes at least two chains engaged and disengaged like a zipper. During operation, interfering portions of the first chain links are alternately engaged with interfering portions of the second chain links so as to inhibit the chains from separating and from being deflected from a linear alignment. This engagement may be referred to as “zipping.” In addition, during operation, interfering portions of the first chain and second chain are alternately disengaged to separate the two chains from each other, this being referred to as “unzipping.” The chain drive assembly may include a pair of sprockets and a pair of storage guides for the individual strands. The sprockets may be positioned so that the chains are deflected and guided around the sprockets, and the interfering portions are engaged or disengaged by the sprockets as the chain links transition between a linear alignment and a deflected alignment.

The chain drive assembly may be utilized with a number of components conventionally used in a garage door system. More specifically, when a movable barrier, such as a garage door, is to be raised, a motor may be energized in a forward direction and the chain drive assembly is lengthened. A first end of the chain drive includes the engaged ends of two or more chains and is coupled directly or with an apparatus to the top of the garage door. When the motor is energized in one direction, sprockets of a head unit may be used to engage the interfering portions of the two chains to lengthen the rigid length of the chain drive and advance the first end of the chain drive into the interior of the garage, thereby raising the door with the chain drive in a push direction. When the motor is energized in a second direction, sprockets may be used to disengage the interfering portions of the two chains to shorten the rigid length of the chain drive. Accordingly, the first end of the chain drive is drawn towards the head unit, and the door is lowered. Once the interfering portions of the links are disengaged from each other, the disengaged chains may be coiled, or otherwise stored, in respective compact storage guides for efficient storage.

A system utilizing the chain drive of the present invention provides a number of benefits. The head unit, or any other component, need not be located on the ceiling. Instead, a garage door system utilizing the chain drive assembly may have a head unit located and mounted in any position where the chain may be connected to the garage door as to provide a force in a push direction. For instance, the head unit may be located on the outer wall that includes the garage door. Although a head unit may be located in a similar orientation when used with a screw-type system, the screw itself would still be required, as well as a mount for the distal end of the screw, the mount requiring the same considerations as the above-discussed chain drive systems.

In addition, this chain drive assembly does not require a transmission rail. The chain drive is able to maintain a linear alignment under compression, and resists transverse forces that would otherwise cause a single chain to deflect from a linear alignment.

A garage door system utilizing a chain drive of the present invention simplifies installation or removal. As discussed above, no component need be mounted to ceilings which may vary in height, a fact reduces the time and complexity of installing or removing the system compared to a conventional system. In addition, no transmission rail, or screw, need be mounted. As a result, a system incorporating the present invention is less expensive, more easily installed, and more easily transferred and reinstalled than a typical system.

### BRIEF DESCRIPTION OF THE DRAWINGS

In the drawings, FIG. 1 is a fragmentary side elevation view in partial cross-section of a garage door system incorporating a chain drive assembly of the present invention;

FIG. 2 is a fragmentary side elevation view in partial cross-section of the garage door system of FIG. 1;

FIG. 3 is a perspective view of a first embodiment of a chain drive of the present invention;

FIG. 4 is a perspective view of a second embodiment of a chain drive of the present invention;

FIG. 5A is a perspective view of a third embodiment of a chain drive of the present invention;

FIG. 5B is a side elevation view of an interfering link of the chain drive of FIG. 5A;

FIG. 5C is a top plan view of the interfering link of FIG. 5B;

FIG. 6A is a perspective view of a fourth embodiment of a chain drive of the present invention;

FIG. 6B is a front elevation view of an interfering link of the chain drive of FIG. 6A;

FIG. 6C is a side elevation view of the interfering link of FIG. 6B; and

FIG. 6D is a top plan vie of the interfering link of FIG. 6B.

### DETAILED DESCRIPTION OF THE PREFERRED EMBODIMENT

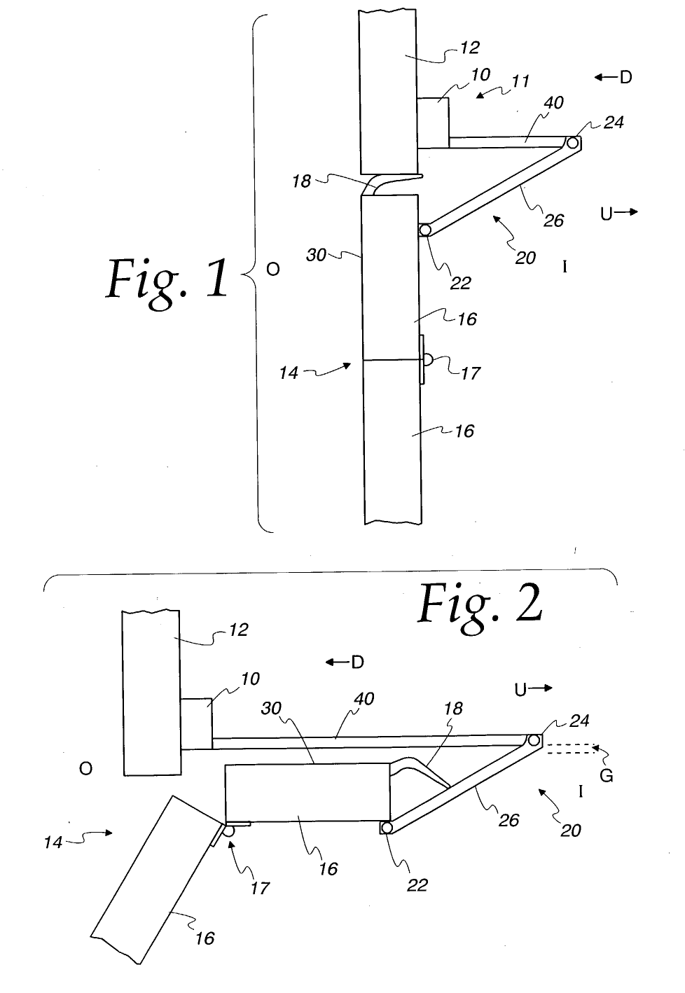

Referring initially to FIGS. 1 and 2, a head unit 10 of a garage door system 11 is shown attached to an outer wall 12 of a structure, such as a garage, and attached to a movable barrier such as a garage door 14. As depicted in FIG. 1, the garage door 14 is in a closed position. In FIG. 2, the garage door 14 is in an intermediate (partially open) position. The garage door 14 includes a plurality of door sections 16 which span vertically from a ground level (not shown) to a point below the outer wall 12. Each door section 16 is connected to any abutting door section with a hinge 17. A rubber seal 18 is provided attached to the outer wall 12 or, preferably, to the top of the garage door 14. When the garage door 14 is in a closed position, the seal 18 is deflected so as to press against the outer wall 12 and closes the space between the top of the garage door 14 and the outer wall 12. The seal 18, for instance, minimizes the air or other environmental passage between an inside region 1 within the garage and an outdoor region 0 outside of the garage. When the garage door 14 is not in a closed position, the seal 18 straightens to a natural position (FIG. 2).

As is known in the art, the garage door system 11 may include garage door rails (not shown) along which the sides of the garage door 14 are moved, and a controller (not shown) located in the head unit 10 that is operative to energize a motor (not shown) to raise and lower the garage door 14. Many garage door systems 11 also include a hand-held transmitter unit (not shown) adapted to send signals to an antenna (not shown) positioned on the head unit 10, and a wall control (not shown) connected to the head unit 10.

The head unit 10 operates to direct the chain drive 40 in a horizontal, linear direction. To raise the garage door 14, the chain drive 40 is operated in a push direction, represented by the arrow U. To lower the garage door 14, the chain drive 40 is operated in a reverse direction, represented by the arrow D.

The head unit 10 is coupled to the garage door 14 with a bracket system 20. The bracket system 20 includes a first bracket 22, a second bracket 24, and an arm 26 and is aligned with a path of travel of a chain drive 40 of the garage door system 11. The first bracket 22 is attached to the garage door 14 and is rotatably secured to the arm 26. The arm 26 is rotatably secured to the second bracket 24, which is, in turn, in secured communication with a distal end of the chain drive 40. The natural position of the seal 18 (FIG. 2) is such that the seal does not interfere with the operation of the bracket system 20. The chain drive 40 is preferably directed in a horizontal direction generally parallel with the position of the garage door 14 in an open position. The bracket system 20 is configured such that the path of travel of the chain drive 40 is as close to the path of travel of the garage door 14. In other words, a gap G exists between the chain drive 40 and the garage door 14 when the door is in an intermediate position: in order to minimize the stress upon the bracket system 20 and the chain drive 40, the gap G should be minimized while not eliminated. In the event the gap G were eliminated, the chain drive 40 would contact and may mar an outer surface 30 of the garage door 14. As the garage door 14 is raised or lowered, the arm 26 rotates so that the force directed by the chain drive 40 remains aligned with the path of travel of the top of the garage door 14 to insure smooth travel of the garage door 14 along garage door rails (not shown).

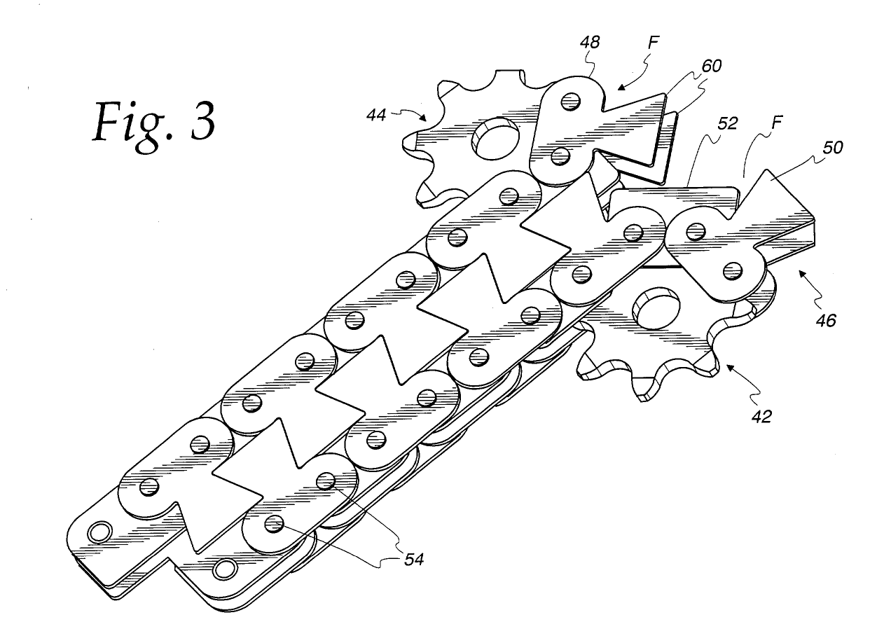

The head unit 10 provides locomotive force to the chain drive 40. The motor (not shown) within the head unit 10 is an electrical motor providing force in two directions, each corresponding to a direction of travel (U, D) of the garage door 14. The motor (not shown) is in communication with a first sprocket 42 and a second sprocket 44 (FIG. 3) and provides rotational power to the sprockets 42, 44. Referring to FIGS. 3-6, the chain drive 40 includes a first chain 46 and a second chain 48. The first sprocket 42 is in sprocket-chain mating relationship with the first chain 46, while the second sprocket 44 is in sprocket-chain mating relationship with the second chain 48. A portion of the chain drive 40 is an engaged relationship E, and a portion is a disengaged relationship F.

Each chain 46, 48 includes pivotally connected links including interfering links 50 and coupling links 52. Other than the ends of each chain 46, 48, each interfering link 50 is connected at each end to a coupling link 52 by a pivot formed by a cylindrical rivet 54, as is known in the field of the art, and the sprockets 42, 44 mate with the cylindrical rivet 52, as is known in the field of the art. In the present embodiment, each interfering link 50 includes an interfering portion, specifically a top and a bottom trapezoidal flange 60 where the greatest portion of each trapezoid extends away from the cylindrical rivets 54. When the interfering links 50 are engaged, the sides of the flanges 60 of the first chain 46 are in a mating relationship with the opposing flanges 60 of the second chain. As the sprockets 42, 44 rotate to extend the chain, the chains 46, 48 are fed between the sprockets 42, 44, and the interfering links 50 are mated in an interlocking position that prevents the chains 46, 48 from being pulled apart and that prevents the chains 46, 48 from being deflected in a direction transverse the direction of the feeding of the chains 46, 48. As the sprockets 42 in the opposite direction to retract the chain, the chains 46, 48 are unmated, or disengaged such that the interfering links 50 and coupling links 52 are free to rotate relative to each other. In the engaged relationship E, the chain drive 40 is able to receive and transmit a force in a push direction. In the disengaged relationship F, the chains 46, 48 of the chain drive 40 are able to be coiled in a manner common to chains linked by cylindrical rivets for mating with a sprocket.

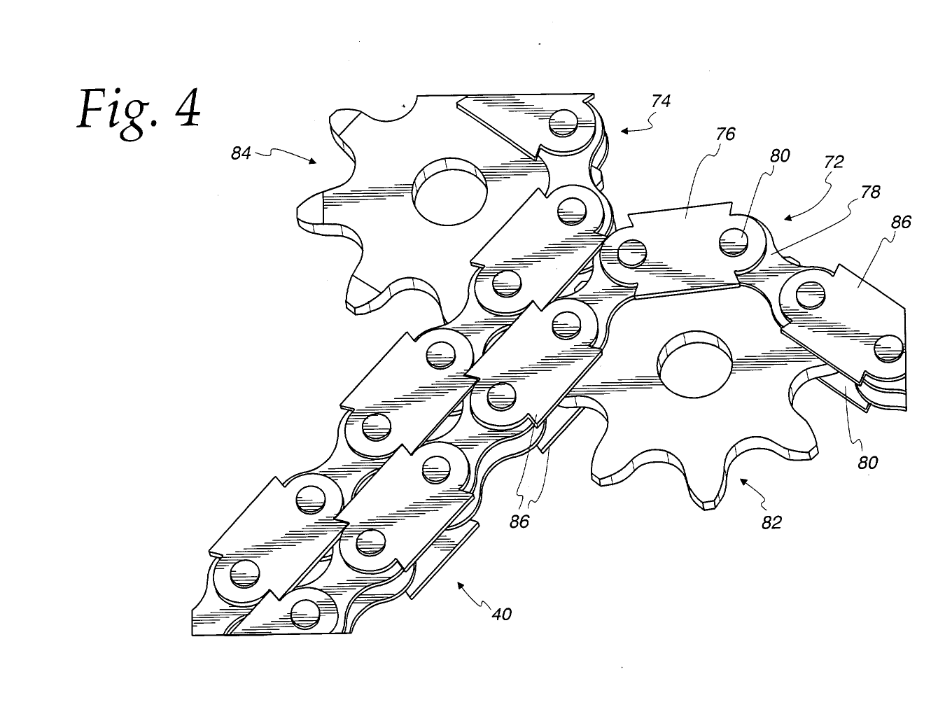

Referring now to FIG. 4, a second embodiment of the chain drive 40 is depicted. The chain drive 40 includes a first and second chain 72, 74 with interfering links 76, and coupling links 78 connected by cylindrical rivets 80 for mating with respective first and second sprockets 82, 84. As discussed above, the interfering links 76 of the first chain 72 have an interfering portion, specifically a top and a bottom trapezoidal flange 86 for mating with trapezoidal flanges of the interfering links 76 of the second chain 74. In the present embodiment, the interfering links 76 have a identical trapezoidal flanges 86 on the non-engaging sides of each interfering link 76. By manufacturing the interfering links 76 in this manner, the assembling each chain 72, 74 is simplified, and the assembly of the chain drive within the head unit 10 is simplified, as the possible orientations for each interfering link 76 and each chain 72, 74 is reduced.

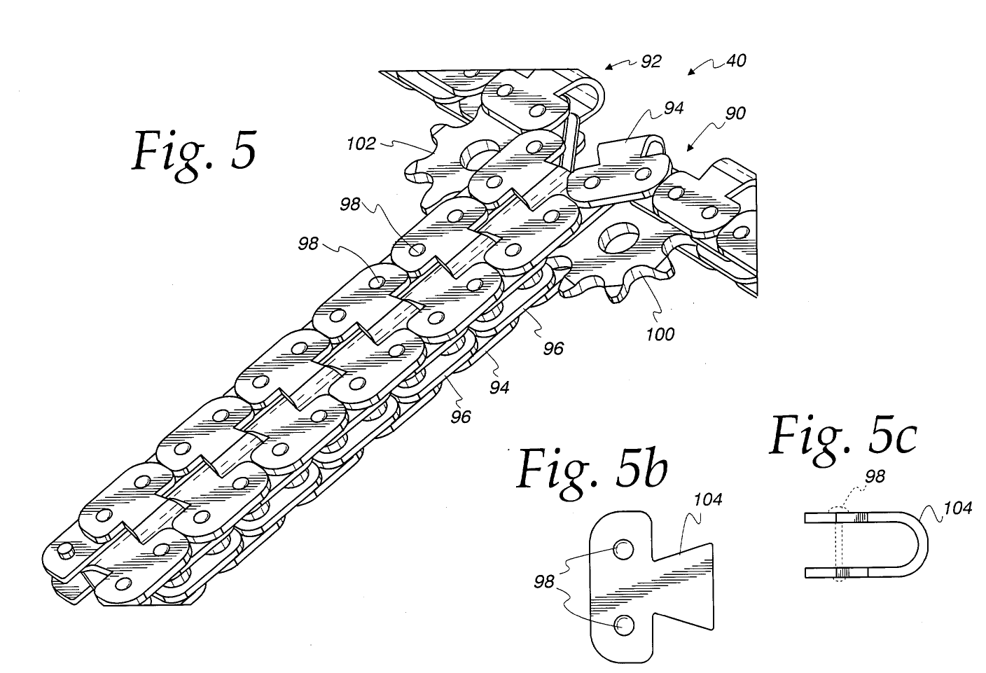

Referring now to FIGS. 5A-C, a third embodiment of the chain drive 40 is depicted. The chain drive 40 includes a first and second chain 90, 92 with interfering links 94 and coupling links 96 connected by cylindrical rivets 98 for mating with respective first and second sprockets 100, 102. Referring to FIG. 5B, the interfering links 94, when viewed from a top plan view or bottom plan view, have a profile including a trapezoid as in the previous two embodiments. However, referring to FIG. 5C, while the previous two embodiments include a pair of trapezoidal flanges, the interfering portion of present embodiment includes a single piece 104 that mates with the rivets 98 at the top and at the bottom, the single piece 104 being viewed in cross-section as a U-shape. As discussed above, the interfering links 94 of the first chain 90 mate with the interfering links 94 of the second chain 92.

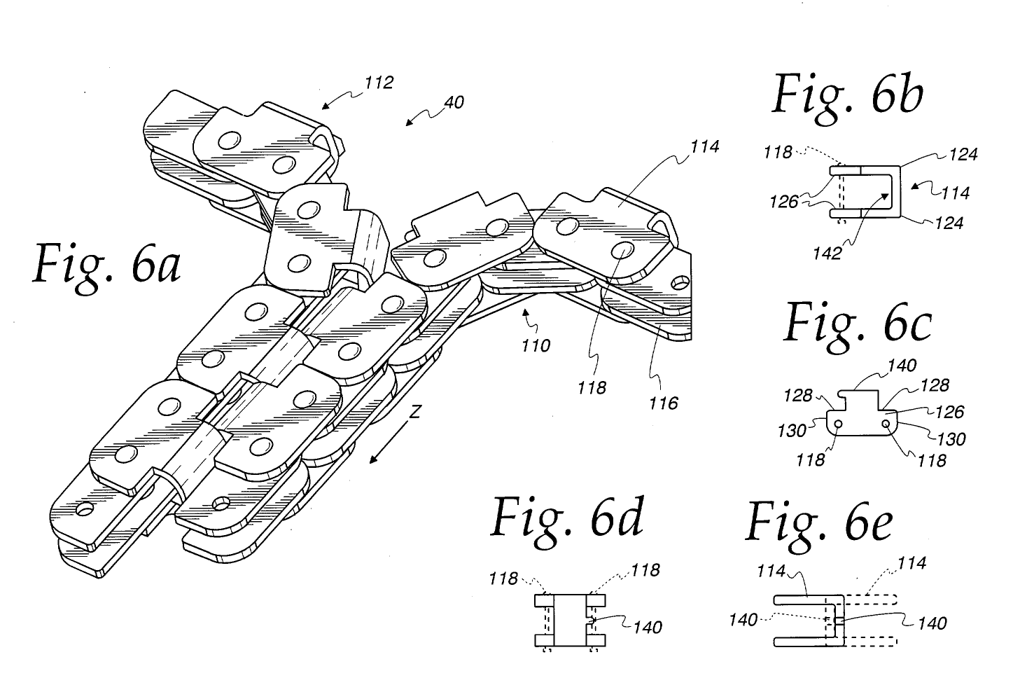

Referring now to FIGS. 6A-D, a fourth embodiment of the chain drive 40 is depicted. The chain drive 40 includes a first and second chain 110, 112 with interfering links 114 and coupling links 116 connected by cylindrical rivets 118 for mating with respective first and second sprockets (not shown). Referring to FIG. 6B, the interfering links 114 have a profile of three sides generally at right angles, the corners 124 of which are slightly rounded. Referring to FIG. 6C, when viewed from a top plan view or bottom plan view, the interfering links 114 have a top and bottom base portion 126 with generally straight shoulders 128 which abut straight shoulders 128 of the opposing chain when in an engaged position. The base portion 126 further includes peripheral sides 130 which are generally straight and at least a contact portion of which forms a right angle with the shoulders 128. Each peripheral side 130 abuts a peripheral side 130 of another interfering link (FIG. 6A). Due to the shape of the base portions 124 of the interfering links 114, each chain 110, 112 is itself a push/pull chain that is deflectable in one direction. That is, each chain 110, 112 may be deflected in the direction as depicted. However, neither chain 110, 112 may be deflected in an opposite direction. Therefore, when the chains 110, 112 are engaged, each provides a constraint against for the other by virtue of the configuration and mating of the base portions 124 to base portions 124 of opposing as well as abutting interfering links 114.

Referring to FIG. 6D, the interfering links 114 have an interfering portion, specifically a lateral prong 140. As can be seen in FIG. 6E, when the chains 110, 112 are engaged, each lateral prong 140 is mated with an opposing interfering link 114 by abutting an interior portion 142 (FIG. 6B). As discussed above, the interfering links 114 of the first chain 110 mate with the interfering links 114 of the second chain 112. In the present embodiment, it is preferred that each interfering link 114 includes only a single lateral prong 140 which is located on the interfering link 114 in a direction in the direction of travel of the chains 110, 112 when the chains are being engaged, represented by arrow Z. Although, as an alternative, each interfering link 114 may include a lateral prong 140 on an opposite side as well, such would cause undesirable interference when the chains 110, 112 are disengaged.

It is clear that a number of embodiments and configurations may be fashioned whereby links of a first chain may engage and interfere with links of a second chain in order to prevent the links from being deflected from a linear orientation. It is also clear that a number of chains may be employed. For instance, a central chain (not shown) may be provided wherein two chains (not shown) laterally disposed of the central chain both include interfering links in order to prohibit the engaged chains from deflecting from a linear orientation. Furthermore, although the present invention has been discussed with reference to a conventional garage door that raises and lowers, the present invention may be utilized with a garage door that moves laterally. In this case, the push/pull ability of the chain drive would be utilized where the head unit is located at one side of the door, and the is required to provide a force without the benefit of gravity. For example, doors of an aircraft hangar or of a barn are often moved laterally without any place other than an outer wall to mount a door system. While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A chain drive with a linear orientation comprising:
at least two chains each including a plurality of pivotally connected links, the links including interfering links wherein the interfering links of one chain may be engaged with the interfering links of a second chain whereby the chain drive may communicate a force in a linear direction when the chain drive is in compression.

2. The chain drive of claim 1 wherein chains may be disengaged by disengaging the interfering links of the first chain from the interfering links of the second chain, and wherein each disengaged chain may be stored compactly by pivoting the links.

3. The chain drive of claim 1 wherein each chain including interfering links further includes coupling links connecting the interfering links.

4. The chain drive of claim 1 wherein the chain drive may communicate a force in a linear direction when the chain drive is in tension.

5. The chain drive of claim 1 wherein the first and second chains are adjacent to each other.

6. The chain drive of claim 1 wherein the first and second chains are each attached to at least a third chain.

7. The chain drive of claim 1 wherein the interfering links of the first chain engaged with the interfering links of the second chain substantially prohibit pivoting of the links.

8. The chain drive of claim 7 wherein the engaged interfering links substantially prohibit pivoting of the links when a transverse force is applied to the chain drive.

9. The chain drive of claim 1 wherein the engaged interfering links substantially prohibit the separation of the first and second chains.

10. The chain drive of claim 1 wherein the chains may be engaged and disengaged by a plurality of sprockets.

11. The chain drive of claim 10 wherein each chain including interfering links is provided at least one sprocket.

12. The chain drive of claim 1 wherein the interfering links include at least one pivot, wherein the interfering links include an interfering portion located distally from the pivot, and wherein the interfering portions of the first chain face the interfering portions of the second chain.

13. The chain drive of claim 12 wherein the interfering portions of the links of the first chain are complementary to the interfering portions of the second chain.

14. The chain drive of claim 13 wherein the interfering portions of each chain are identical.

15. The chain drive of claim 13 wherein the interfering links further include interfering portions facing a direction opposite the interfering portions of the engaged with chain.

16. The chain drive of claim 12 wherein the interfering portions are substantially trapezoidal.

17. The chain drive of claim 12 wherein the interfering portion are prongs, wherein interfering links of each chain have a rear face oriented substantially away from the chain with which each chain is engaged, the prong abutting the rear face.

18 The chain drive of claim 12 wherein each chain with interfering links includes a base portion with peripheral sides, wherein the peripheral side of one interfering link abuts the peripheral side of a second interfering link thereby substantially prohibiting the links from deflecting from a linear orientation in one direction when the chain is engaged and when the chain is disengaged while permitting the links to be deflected from a linear orientation in a second direction.

19 The chain drive of claim 18 wherein the peripheral sides have a contact portion substantially at a right angle from the linear orientation, and wherein the contact portion of one interfering link abuts the contact portion of a second interfering link.

20. The chain drive of claim 12 wherein each chain with interfering links includes a base portion including a shoulder substantially parallel to linear orientation of the engaged chain drive, wherein the shoulder of each engaged interfering link of the first chain abuts a surface of an interfering link of the second chain.

21. The chain drive of claim 20 wherein the base portion further includes peripheral sides, wherein the peripheral side of one interfering link abuts the peripheral side of a second interfering links thereby substantially prohibiting the links from deflecting from a linear orientation in one direction when the chain is engaged and when the chain is disengaged while permitting the links to be deflected from a linear orientation in a second direction.

22. A chain drive assembly comprising:
a chain drive with a linear orientation and including at least two chains each including a plurality of pivotally connected links, the links including interfering links wherein the interfering links of one chain may be engaged with the interfering links of a second chain whereby the chain drive may communicate a force in a linear direction when the chain drive is in compression; and
at least a rotating sprocket for each chain for engaging and disengaging the chains.

23. The chain drive assembly of claim 22 wherein chains may be disengaged by disengaging the interfering links of the first chain from the interfering links of the second chain, and wherein each disengaged chain may be stored compactly by pivoting the links.

24. The chain drive assembly of claim 23 wherein the chain drive assembly may communicate a force by rotating the sprockets, and wherein the sprockets communicate the force to the chain drive in first linear direction.

25. The chain drive assembly of claim 24 wherein the first and second chains are adjacent to each other.

26. The chain drive assembly of claim 24 wherein the first and second chains are each attached to at least-a third chain.

27. The chain drive assembly of claim 24 wherein the interfering links of the first chain engaged with the interfering links of the second chain substantially prohibit pivoting of the links when a transverse force is applied to the chain drive.

28. The chain drive assembly of claim 24 further including a reversible motor which may deliver force in the first linear direction by rotating the sprockets in a first direction, and which may deliver force in a second linear direction by rotating the sprockets in a second direction, and the chain drive being engaged in a linear orientation when the sprockets are rotated in the first direction and the chain drive being disengaged when the sprockets are rotated in the second direction.

29. A movable barrier system for moving a movable barrier between a first position to a second position, the system comprising:
a movable barrier;
a head unit including:
a chain drive assembly including:
a chain drive with a linear orientation and including at least two chains each including a plurality of pivotally connected links, the links including interfering links wherein the interfering links of one chain may be engaged with the interfering links of a second chain whereby the chain drive may communicate a force in a linear direction when the chain drive is in compression; and
at least a rotating sprocket for each chain for engaging and disengaging the chains; and
a reversible motor which may deliver force in the first linear direction by rotating the sprockets in a first direction, and which may deliver force in a second linear direction by rotating the sprockets in a second direction, and the chain drive being engaged in a linear orientation when the sprockets are rotated in the first direction and the chain drive being disengaged when the sprockets are rotated in the second direction; and
a coupling for connecting the chain drive to the movable barrier.

30. The movable barrier system of claim 29 wherein the chains may be disengaged by disengaging the interfering links of the first chain from the interfering links of the second chain, and wherein each disengaged chain may be stored compactly by pivoting the links.

31. The movable barrier system of claim 30 wherein the chain drive assembly may communicate a force by rotating the sprockets, and wherein the sprockets communicate the force to the chain drive in first linear direction.

32. The movable barrier system of claim 31 wherein the interfering links of the first chain engaged with the interfering links of the second chain substantially prohibit pivoting of the links when a transverse force is applied to the chain drive.

33. The movable barrier system of claim 29 wherein the movable barrier is a garage door.

34. The movable barrier system of claim 29 wherein the movable barrier is moved from the first position to the second position when the sprockets are rotated in the first direction, and wherein the movable barrier is moved from the second position to the first position when the sprockets are rotated in the second direction.

35. The movable barrier systems of claim 29 wherein the movable barrier system is secured to a wall, wherein the movable barrier closes a space in the wall.

36. A method for moving a movable barrier between a first position and a second position, the method comprising:
attaching one end of a first chain to one end of a second chain to form the first end of a chain drive;
coupling the first end of the multi-strand chain to the movable barrier;
rotating a first sprocket in mating relationship with the first chain;
engaging interfering links of the first chain with interfering links of the second chain to move the barrier from the first position to the second position; and
disengaging interfering links of the first chain from the interfering links of the second chain to move the barrier from the second position to the first position.

37. The method of claim 36 further comprising:
rotating the sprocket in a first direction for engaging the interfering links; and
rotating the sprocket in a second direction for disengaging the interfering links.

38. The method of claim 37 further comprising energizing a reversible motor for rotating the sprocket.

39. The method of claim 38 wherein the motor communicates a force to the sprocket, the sprocket communicates a force to the chain drive, and the chain drive moves the barrier in a direction corresponding to the direction of the rotating sprocket.
